(19) United States
(12) Patent Application Publication
(10) Pub. No.: US 2026/0156635 A1
(43) Pub. Date: Jun. 4, 2026

(54) WIRELESS COMMUNICATION METHOD AND DEVICE THEREOF

(71) Applicant: ZTE CORPORATION, Shenzhen (CN)

(72) Inventors: Jianqiang DAI, Shenzhen (CN); Jiajun XU, Shenzhen (CN); Bo DAI, Shenzhen (CN); Jun XU, Shenzhen (CN); Mengzhu CHEN, Shenzhen (CN)

(73) Assignee: ZTE CORPORATION, Shenzhen (CN)

(21) Appl. No.: 19/279,353

(22) Filed: Jul. 24, 2025

Related U.S. Application Data
(63) Continuation of application No. PCT/CN2023/086668, filed on Apr. 6, 2023.

(51) Int. Cl. H04W 72/115; H04W 72/0453; H04W 72/1268; H04W 72/232

(52) U.S. Cl. CPC H04W 72/115; H04W 72/0453; H04W 72/1268; H04W 72/232

(57) ABSTRACT

A wireless communication method for use in a wireless terminal is disclosed. The method comprises receiving, from a wireless network node, a control signaling, determining, based on the control signaling, a plurality of transmission occasions in a plurality of periods, wherein each period comprises multiple transmission occasions, transmitting, to the wireless network node, data at one or more resources out of the plurality of transmission occasions in the plurality periods, and transmitting, to the wireless network node, a first network signaling associated with the plurality of transmission occasions in a time duration, wherein the time duration comprises one or multiple periods.

### CROSS-REFERENCE TO RELATED PATENT APPLICATIONS

This application is a Continuation of US Application PCT/CN2023/086668, filed Apr. 6, 2023, incorporated herein by reference in its entirety.

### TECHNICAL FIELD

This document is directed generally to wireless communications, and in particular to 5G communications.

### BACKGROUND

The extended Reality (XR) (e.g., AR (Augmented Reality) and VR (Virtual Reality)) techniques arise in multiple use cases, e.g., immersive gaming, Smart Transport, collaborative and concurrent engineering, etc. From the wireless connection perspective, these use cases are supposed to be supported in an enhanced NR (new radio) wireless network, which require properties of capacity on both high data rate and low network latency.

### SUMMARY

At BS (base station) side, a data burst received and decoded, and rendered for a XR service may contain multiple traffic cycles. Thus, the BS may configure a period of CG (configured grant) for a traffic cycle, wherein CG resources in each CG period are pre-configured. However, the CG resources may be over-configured based on statistic values of packet size. Because a packet size of the data burst for the XR service may vary from one CG period to another CG period, a part of the preconfigured CG resources in one CG period in which a data packet with a small packet size is transmitted may be wasted. As a result, the redundant CG resources are wasted.

This document relates to methods, systems, and devices for CG communications, and in particular to methods, systems, and devices for transmitting information associated with the CG transmission occasions.

The present disclosure relates to wireless communication method for use in a wireless terminal. The method comprises:
receiving, from a wireless network node, a control signaling,
determining, based on the control signaling, a plurality of transmission occasions in a plurality of periods, wherein each period comprises multiple transmission occasions,
transmitting, to the wireless network node, data at one or more resources out of the plurality of transmission occasions in the plurality periods, and
transmitting, to the wireless network node, a first network signaling associated with the plurality of transmission occasions in a time duration, wherein the time duration comprises one or multiple periods.

Various embodiments may preferably implement the following features:

Preferably or in some embodiments, the first network signaling indicates a number of unused transmission occasions which is unused for transmitting the data transmission for all periods in the time duration.

Preferably or in some embodiments, the first network signaling indicates a plurality of values for the multiple periods in the time duration, wherein each value indicates a number of unused transmission occasions which is unused for transmitting the data in corresponding period in the time duration.

Preferably or in some embodiments, the first network signaling indicates a starting period in the time duration.

Preferably or in some embodiments, the transmission occasions in the starting period and the periods after the starting period in the time duration are unused for transmitting the data.

Preferably or in some embodiments, the plurality of transmission occasions is configured by at least one of a plurality of configured grant (CG) configurations, a plurality of CG configuration groups, a plurality of serving cells, a plurality carriers or a plurality of transmission and reception points (TRPs).

Preferably or in some embodiments, the first network signaling comprises at least one of:
one or multiple numbers of unused transmission occasions which are unused for transmitting the data within the one or more periods in the time duration,
one or multiple time windows associated with unused transmission occasions which are unused for transmitting the data in the time duration, or
a bit string indicates whether the transmission occasions in the time duration are used or unused for transmitting the data.

Preferably or in some embodiments, the first network signaling indicates the transmission occasions unused for transmitting the data in the time duration based on at least one characteristic of the transmission occasions in the time duration and the periods in the time duration, wherein the unused transmission occasions are the transmission occasions unused for transmitting the data.

Preferably or in some embodiments, the at least one characteristic of the unused transmission occasions comprises at least one of: CG configurations, CG groups, cells, cell groups, carriers, or TRPs.

Preferably or in some embodiments, the first network signaling indicates the transmission occasions unused for transmitting the data in an order of a characteristic of the transmission occasions in the time duration and then in an order of the periods in the time duration.

Preferably or in some embodiments, the first network signaling indicates the transmission occasions unused for transmitting the data in the time duration in an order of the periods and then in an order of a characteristic.

Preferably or in some embodiments, the characteristic is one of: CG configurations, CG groups, cells, cell groups, carriers, or TRPs.

Preferably or in some embodiments, the first network signaling comprises a bit matrix indicating the transmission occasions unused for transmitting the data in the time duration, wherein columns of the bit matrix are associated with a first characteristic of the transmission occasions in the time duration and rows of the bit matrix are associated with a second characteristic of the transmission occasions in the time duration.

Preferably or in some embodiments, the first characteristic and the second characteristic are two of: periods, CG configurations, CG groups, cells, cell groups, carriers, or TRPs.

Preferably, the first network signaling is transmitted in:
all of the transmission occasions in the time duration,
a 1st transmission occasion in a 1st period in the time duration,
the transmission occasions configured by a preconfigured CG configuration in the time duration,
the transmission occasions in a primary cell and/or a secondary cell in the time duration, or
the transmission occasions in a master cell group and/or a secondary group.

Preferably or in some embodiments, the first network signaling indicates one of configurations for the plurality of transmissions occasions in the plurality of periods.

Preferably or in some embodiments, the first network signaling comprises an indication of whether the first network signaling is used for multiple periods.

Preferably or in some embodiments, the wireless communication method further comprises transmitting, to the wireless network node, a second network signaling associated with the transmission occasions in one of the periods in the time duration.

Preferably or in some embodiments, the second network indicates the used transmission occasions which are used for a data transmission and/or unused transmission occasions which are unused for the data transmission in the period

Preferably or in some embodiments, the wireless communication method further comprises transmitting, to the wireless network node, UE capability information associated with transmitting the first network signaling.

Preferably or in some embodiments, the control signaling comprises a plurality of sets of a time domain offset parameter and a time domain allocation parameter corresponding to the transmission occasions in each period.

Preferably or in some embodiments, the time domain offset parameter indicates an offset relative to a reference subframe number.

Preferably or in some embodiments, the time domain allocation parameter indicates a starting position and a time length.

Preferably or in some embodiments, the control signaling indicates the plurality of sets of the time domain offset parameter and the time domain allocation parameter via a table configured by the wireless network node.

Preferably or in some embodiments, the time domain allocation parameter for all of transmission occasions are the same.

Preferably or in some embodiments, the control signaling is received in a DCI format.

Preferably or in some embodiments, the DCI format indicates multiple time domain offsets and a row index of a table configured by the wireless network node.

Preferably or in some embodiments, each offset indicates a time offset between one transmission occasion and a reference point which is a time slot in which the DCI format is received.

The present disclosure relates to a wireless communication method for use in a wireless network node. The method comprises:
transmitting, to a wireless terminal, a control signaling, wherein a plurality of transmission occasions in a plurality of periods is determined based on the control signaling and each period comprises multiple transmission occasions,
receiving, from the wireless terminal, data at one or more resources out of the plurality of transmission occasions in the plurality periods, and
receiving, from the wireless terminal, a first network signaling associated with the plurality of transmission occasions in a time duration, wherein the time duration comprises one or multiple periods.

Various embodiments may preferably implement the following features:

Preferably or in some embodiments, the first network signaling indicates a number of unused transmission occasions which is unused for transmitting the data transmission for all periods in the time duration.

Preferably or in some embodiments, the first network signaling indicates a plurality of values for the multiple periods in the time duration, wherein each value indicates a number of unused transmission occasions which is unused for transmitting the data in corresponding period in the time duration.

Preferably or in some embodiments, the first network signaling indicates a starting period in the time duration.

Preferably or in some embodiments, the transmission occasions in the starting period and the periods after the starting period in the time duration are unused for transmitting the data.

Preferably or in some embodiments, the plurality of transmission occasions is configured by at least one of a plurality of configured grant (CG) configurations, a plurality of CG configuration groups, a plurality of serving cells, a plurality carriers or a plurality of transmission and reception points (TRPs).

Preferably or in some embodiments, the first network signaling comprises at least one of:
one or multiple numbers of unused transmission occasions which are unused for transmitting the data within the one or more periods in the time duration,
one or multiple time windows associated with unused transmission occasions which are unused for transmitting the data in the time duration, or
a bit string indicates whether the transmission occasions in the time duration are used or unused for transmitting the data.

Preferably or in some embodiments, the first network signaling indicates the transmission occasions unused for transmitting the data in the time duration based on at least one characteristic of the transmission occasions in the time duration and the periods in the time duration, wherein the unused transmission occasions are the transmission occasions unused for transmitting the data.

Preferably or in some embodiments, the at least one characteristic of the unused transmission occasions comprises at least one of: CG configurations, CG groups, cells, cell groups, carriers, or TRPs.

Preferably or in some embodiments, the first network signaling indicates the transmission occasions unused for transmitting the data in an order of a characteristic of the transmission occasions in the time duration and then in an order of the periods in the time duration.

Preferably or in some embodiments, the first network signaling indicates the transmission occasions unused for transmitting the data in the time duration in an order of the periods and then in an order of a characteristic.

Preferably or in some embodiments, the characteristic is one of: CG configurations, CG groups, cells, cell groups, carriers, or TRPs.

Preferably or in some embodiments, the first network signaling comprises a bit matrix indicating the transmission occasions unused for transmitting the data in the time duration, wherein columns of the bit matrix are associated with a first characteristic of the transmission occasions in the time duration and rows of the bit matrix are associated with a second characteristic of the transmission occasions in the time duration.

Preferably or in some embodiments, the first characteristic and the second characteristic are two of: periods, CG configurations, CG groups, cells, cell groups, carriers, or TRPs.

Preferably or in some embodiments, the first network signaling is transmitted in:
all of the transmission occasions in the time duration,
a 1st transmission occasion in a 1st period in the time duration,
the transmission occasions configured by a preconfigured CG configuration in the time duration,
the transmission occasions in a primary cell and/or a secondary cell in the time duration, or
the transmission occasions in a master cell group and/or a secondary group.

Preferably or in some embodiments, the first network signaling indicates one of configurations for the plurality of transmissions occasions in the plurality of periods.

Preferably or in some embodiments, the first network signaling comprises an indication of whether the first network signaling is used for multiple periods.

Preferably or in some embodiments, the wireless communication method further comprises receiving, from the wireless terminal, a second network signaling associated with the transmission occasions in one of the periods in the time duration.

Preferably or in some embodiments, the second network indicates the used transmission occasions which are used for a data transmission and/or unused transmission occasions which are unused for the data transmission in the period.

Preferably or in some embodiments, the wireless communication method further comprises receiving, from the wireless terminal, UE capability information associated with transmitting the first network signaling.

Preferably or in some embodiments, the control signaling comprises a plurality of sets of a time domain offset parameter and a time domain allocation parameter corresponding to the transmission occasions in each period.

Preferably or in some embodiments, the time domain offset parameter indicates an offset relative to a reference subframe number.

Preferably or in some embodiments, the time domain allocation parameter indicates a starting position and a time length.

Preferably or in some embodiments, the control signaling indicates the plurality of sets of the time domain offset parameter and the time domain allocation parameter via a table configured by the wireless network node.

Preferably or in some embodiments, the time domain allocation parameter for all of transmission occasions are the same.

Preferably or in some embodiments, the control signaling is transmitted in a DCI format.

Preferably or in some embodiments, the DCI format indicates multiple time domain offsets and a row index of a table configured by the wireless network node.

Preferably or in some embodiments, each offset indicates a time offset between one transmission occasion and a reference point which is a time slot in which the DCI format is received.

The present disclosure relates to a wireless terminal, comprising:
a communication unit, configured to receive, from a wireless network node, a control signaling,
a processor, configured to determine based on the control signaling, a plurality of transmission occasions in a plurality of periods, wherein each period comprises multiple transmission occasions,
wherein the communication unit is further configured to:
transmit, to the wireless network node, data at one or more resources out of the plurality of transmission occasions in the plurality periods, and
transmit, to the wireless network node, a first network signaling associated with the plurality of transmission occasions in a time duration, wherein the time duration comprises one or multiple periods.

Various embodiments may preferably implement the following feature:

Preferably or in some embodiments, the processor is further configured to perform any of the aforementioned wireless communication methods.

The present disclosure relates to a wireless network node, comprising:
a communication unit, configured to:
transmit, to a wireless terminal, a control signaling, wherein a plurality of transmission occasions in a plurality of periods is determined based on the control signaling and each period comprises multiple transmission occasions,
receive, from the wireless terminal, data at one or more resources out of the plurality of transmission occasions in the plurality periods, and
receive, from the wireless terminal, a first network signaling associated with the plurality of transmission occasions in a time duration, wherein the time duration comprises one or multiple periods.

Various embodiments may preferably implement the following feature:

Preferably or in some embodiments, the wireless network node further comprises a processor configured to perform any of the aforementioned wireless communication methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The invention is specified by the independent claims. Preferred embodiments are defined in the dependent claims. In the following description, although numerous features may be designated as optional, it is nevertheless acknowledged that all features comprised in the independent claims are not to be read as optional.

The above and other aspects and their implementations are described in greater detail in the drawings, the descriptions, and the claims.

### BRIEF DESCRIPTION OF THE DRAWINGS

FIG. 1 shows a schematic diagram of CG transmission according to an embodiment of the present disclosure.

FIG. 2 shows a schematic diagram of CG transmission according to an embodiment of the present disclosure.

FIG. 3 shows a schematic diagram of CG transmission according to an embodiment of the present disclosure.

FIGS. 4 to 17 show schematic diagrams of UCI structures according to embodiments of the present disclosure.

FIG. 18 shows a schematic diagram of a configuration of multiple CG PUSCH transmission occasions in a CG period according to an embodiment of the present disclosure.

FIG. 19 shows a schematic diagram of a network architecture according to an embodiment of the present disclosure.

FIG. 20 shows an example of a schematic diagram of a wireless terminal according to an embodiment of the present disclosure.

FIG. 21 shows an example of a schematic diagram of a wireless network node according to an embodiment of the present disclosure.

FIG. 22 shows a flowchart of a method according to an embodiment of the present disclosure.

FIG. 23 shows a flowchart of a method according to an embodiment of the present disclosure.

### DETAILED DESCRIPTION

In an embodiment, uplink control information (UCI) is applied for a time duration (e.g., a CG period) where the traffic is transmitted in a part of transmission occasions. That is, in one time duration, one or more transmission occasions may not be used (e.g., for data transmission) and the UCI is configured to indicate the related information to the BS (e.g., gNB).

In the present disclosure, the transmission occasion which is not used (e.g., for the data transmission) may be called unused transmission occasion. Similarly, the transmission occasion which is used (e.g., for the data transmission) may be called used transmission occasion.

In the present disclosure, the transmission occasion or the occasion may be equal to a CG (configured grant) PUSCH (physical uplink shared channel) occasion or a CG occasion, and vice versa.

In an embodiment, the UCI is an indication of the unused transmission occasion(s) within a time duration. The time duration may comprise one or more CG periods.

In an embodiment, the UCI can be an indication of the unused transmission occasion(s) within a time duration, where the transmission occasions are configured by multiple CG configurations and/or multiple carriers and/multiple TRPs (Transmission and Reception Points).

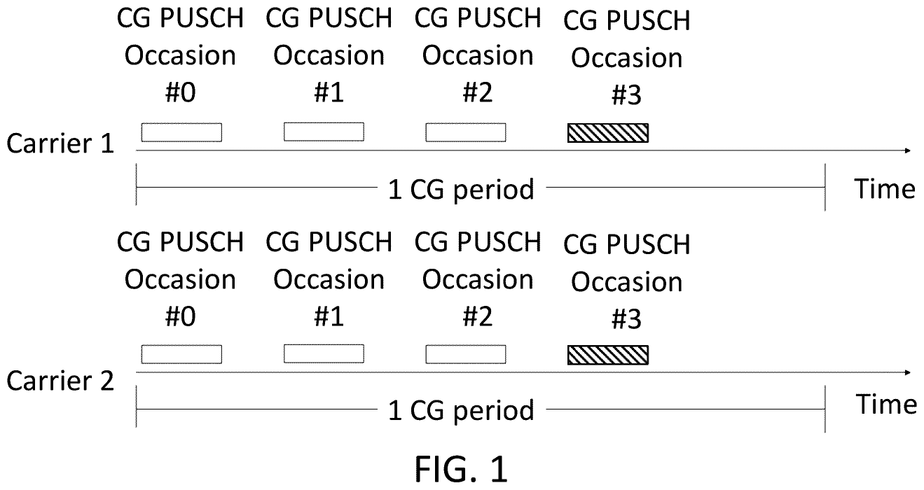

FIG. 1 shows a schematic diagram of CG transmission according to an embodiment of the present disclosure. In FIG. 1, CG PUSCH occasions #3 in both carrier 1 and carrier 2 are unused transmission occasions. In an embodiment of the present disclosure, the UCI can indicate the used/unused transmission occasion(s) configured by multiple carriers in one time duration, so as to reduce the signal overhead.

In an embodiment, the information of this UCI means/indicates which transmission occasion(s) within the time duration is unused. Based on the information, the gNB can re-scheduled these unused resource (i.e., the resource preconfigured for the unused transmission occasion(s)).

### UE Side

In an embodiment, the UCI is/comprises an indication of unused CG occasion(s) within a time duration. In this embodiment, the time duration may comprise single CG period or multiple CG periods.

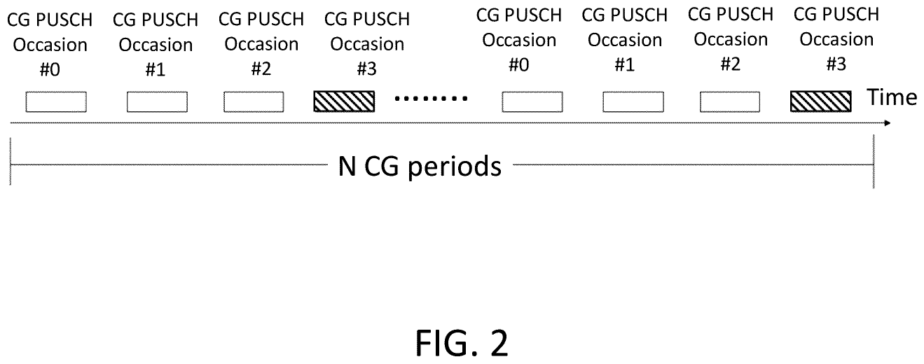

FIG. 2 shows a schematic diagram of CG transmission according an embodiment of the present disclosure. In this embodiment, the UCI is/comprises an indication of unused CG occasion(s) within a time duration which can be/comprise N CG periods, where N is an integer greater than 1. Specifically, the traffic at the N CG periods is (assumed to be) the same or similar and the resource usage at each CG period is also the same or similar. In an embodiment, the UCI is transmitted to the BS, to indicate that the last N1 CG PUSCH transmission occasion(s) in each CG period within the time duration is unused, where N1 is a positive integer. In FIG. 1, N1=1.

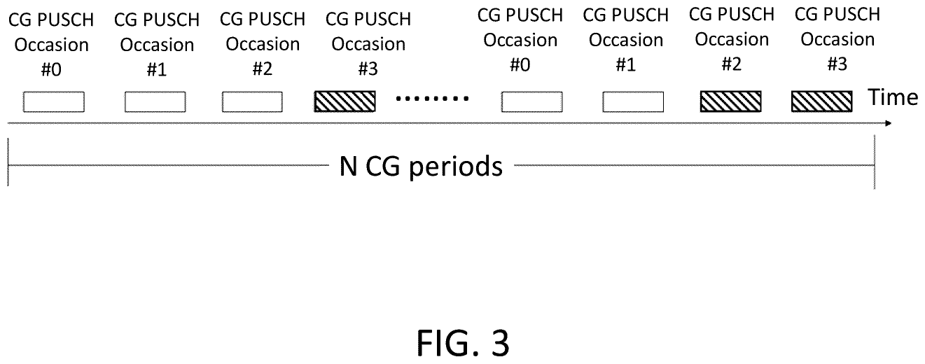

FIG. 3 shows a schematic diagram of CG transmission according to an embodiment of the present disclosure. In FIG. 3, the traffic at multiple CG periods are varied, and UE is able to predict the data volume. For instance, in the 1st CG period, the CG PUSCH occasion #3 is unused for the data transmission. While in the last CG period, the CG PUSCH occasions #2 and #3 are unused for the data transmission. In this embodiment, the UCI may indicate the unused CG occasion(s) in the time duration. For example, UCI indicates that the last N1 CG occasion(s) in 1st period in the time duration is the unused transmission occasion(s), the last N2 CG occasion(s) in 2nd period in the time duration is the unused transmission occasion(s), and so on. As a result, the content of the UCI can be (N1, N2, . . . , NN) for the indication of unused CG occasion(s) in the N CG periods.

In an embodiment, the UCI indicates that the occasion(s) in a certain period in the time duration and all occasions after the certain period within the time duration are unused.

In an embodiment, the UCI indicates that the occasion(s) at the K-th period and all occasions after the K-th period are unused. For instance, the CG PUSCH occasions are configured via a CG configuration, wherein CG PUSCH occasion(s) across K-1 CG periods are configured and are used for a video frame transmission and the rest of resources in the time duration (e.g., a traffic cycle of 16.67 ms) are unused. Under such condition, the UE may transmit the UCI indicating that the occasion at the K-th period and all occasions after the K-th period are unused.

In an embodiment, the CG PUSCH occasions in the time duration are configured by multiple CG configurations, or multiple CG group, or in multiple carriers/cells, or at multiple TRPs. In this embodiment, the UCI indicates the unused resource out of all CG PUSCH occasions in the time duration.

In an embodiment, the content in the UCI may comprise at least one of:
the number of unused CG PUSCH occasions with in N CG periods;
a time window with in N CG periods; or
a bit string, wherein each bit indicates a CG PUSCH occasion with in N CG periods is used or not.

### UCI Indicating Multiple CG Configurations

In an embodiment, the UCI indicates unused transmission occasions from one or more CG configurations in one or more time durations. The time duration can be: a number of slots, a time period associated with a number of HARQ process IDs, a number of milliseconds

In the embodiment of the UCI indicating the unused transmission occasions of one or more CG configurations in one or more time durations, the content structure of the UCI may be in an order of the CG configuration first and then in an order of time.

In an embodiment, the content of the UCI is based on an increasing order of the CG configuration indexes (e.g., ConfiguredGrantConfigIndex).

In an embodiment, the content of the UCI is based on an increasing order of the CG group indexes.

In an embodiment, the content of UCI is based on a priority order of the CG group indexes.

In an embodiment, the order of indication of the unused CG occasions is pre-defined by the BS.

For example, the unused CG occasions with/having a CG occasion index 1, a CG index 2 and a CG index 3 are indicated by one UCI. The content of this UCI could be {indication for CG occasion index 2, indication for CG occasion index 3, indication for CG occasion index 1}.

In an embodiment, the UCI consists of or comprises one or more bit blocks, where each bit block is corresponding to one CG configuration and each block comprises information of the number of unused transmission occasions of the corresponding CG configuration.

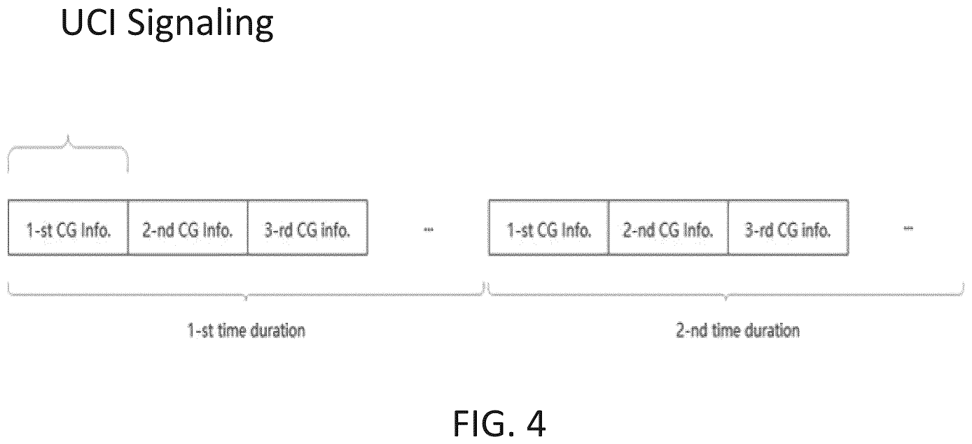

FIG. 4 shows a schematic diagram of a UCI content structure according to an embodiment of the present disclosure. In the embodiment shown in FIG. 4, the UCI content structure is in an order of a bit block for multiple CG configurations in a first time duration, a bit block for multiple CG configurations in a second time duration, and so on.

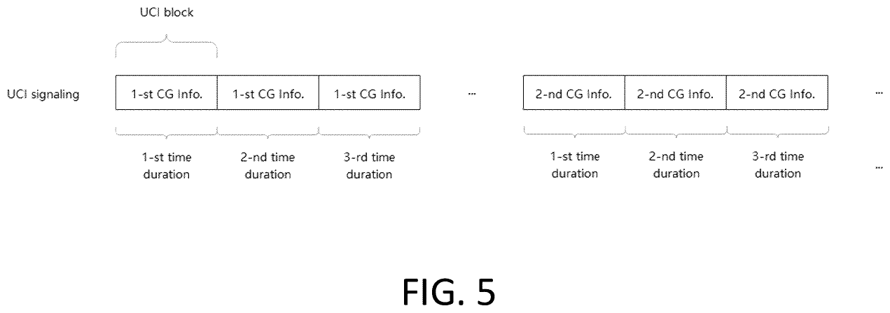

FIG. 5 shows a schematic diagram of a UCI content structure according to an embodiment of the present disclosure. In the embodiment shown in FIG. 5, the UE content structure is in an order of bit blocks for multiple time durations for a 1st CG configuration, bit blocks for multiple time durations for a 2nd CG configuration, and so on.

### Bit Matrix

In an embodiment, a bit matrix is used as the indication (in the UCI) for unused transmission occasions and/or used transmission occasions from one or more CG configurations.

For example, the bit matrix may comprise: indication of N transmission occasions in the M CG configurations in a plurality of time durations, where N and M are integers.

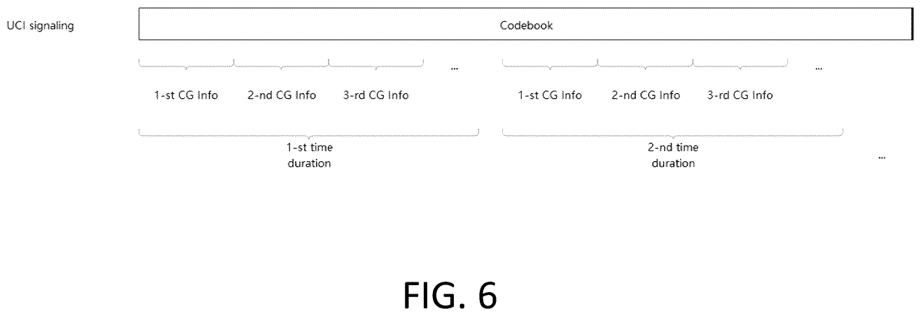

As an alternative, the bit matrix indicates the transmission occasions of CG configuration following the order shown in FIG. 6. In particular the bit matrix is in the order of the indication of the transmission occasions for the CG configurations in the 1st time duration, the indication of the transmission occasions for the CG configurations in the 2nd time duration and so on.

Note that, in FIG. 6, the bit matrix is depicted as 1 row. As an alternative, the bit matrix may be in a form with multiple columns and multiple rows. For instance, the bit matrix may be an M*N matrix.

In an embodiment, the M*N matrix can denote the indication of the unused CG occasion, wherein each row is associated to occasion index in the corresponding time domain and each column is associated with one CG configuration index. In the present disclosure, the M*N matrix may be named as Bit matrix form of indication-Type 0.

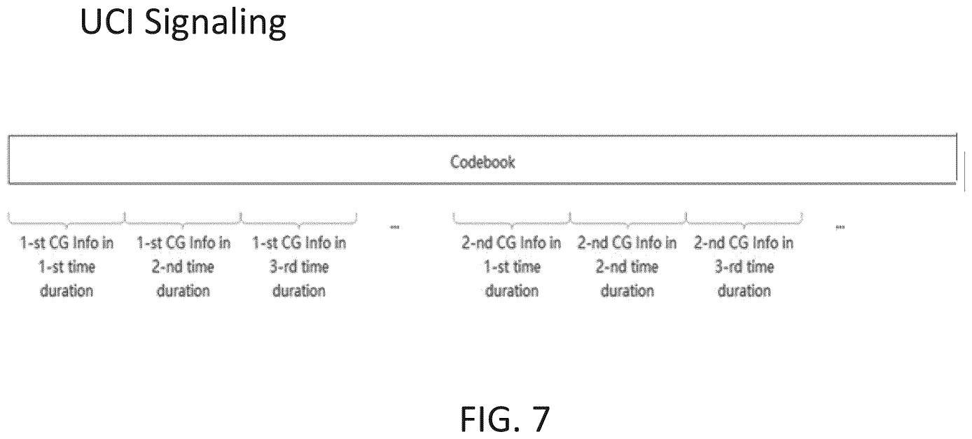

FIG. 7 shows a schematic diagram of the bit matrix indicating the transmission occasions of the CG configurations according to an embodiment of the present disclosure. In FIG. 7, the content in the bit matrix is in the order of indication for multiple CG periods in a 1st CG configuration, the for multiple CG periods in a 2nd CG configuration, and so on.

### Timing of Transmitting UCI for Multiple CG Configurations:

In an embodiment, the UCI can be transmitted at all transmission occasions in a plurality of time durations (e.g., a plurality of CG periods).

In an embodiment, the UCI is transmitted in the 1st transmission occasion in the 1 st time duration. In this embodiment, the transmission occasion in which the UCI is transmitted belongs to the pre-configured CG configuration(s).

In an embodiment, the UCI is transmitted in the transmission occasions which are the preconfigured CG configuration(s).

The above embodiments of the UCI indicating the unused transmission occasions for multiple CG configurations in multiple time durations may also be applied for multiple cells, multiple carriers, or multiple TRPs as illustrated in the following embodiments.

### UCI Indicating Multiple Cells

In some embodiments, the content of the UCI is based on an increasing order of multiple cell index (e.g., CellIdentity).

In an embodiment, the UCI could be {indication for PCell, indication for SCell}.

In an embodiment, the content of UCI is based on a priority order of the serving cells.

In an embodiment, the UCI could be {indication for MCG, indication for SCG}.

In an embodiment, the content of UCI is based on an order of cell group indexes, e.g., CellGroupId.

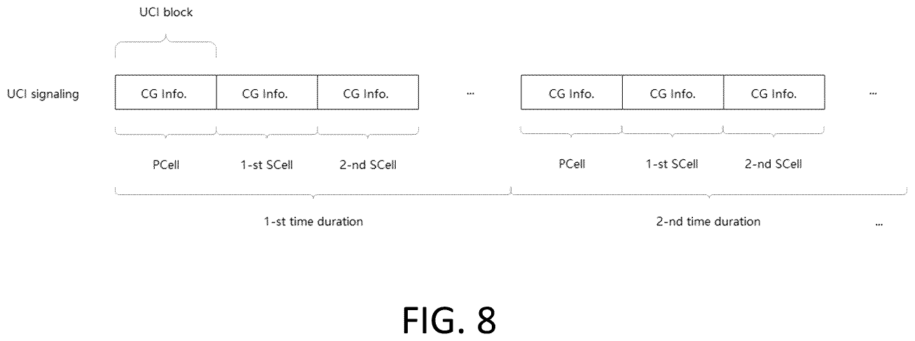

FIG. 8 shows a schematic diagram of a UCI content structure according to an embodiment of the present embodiment, In FIG. 8, the UCI indicates the unused transmission occasions for one or more cells in one or more time durations. Note that the UCI content is in an order of PCell, 1st SCell, 2nd SCell in the 1st time duration, PCell, 1st SCell, 2nd SCell in the 2nd time duration, and so on.

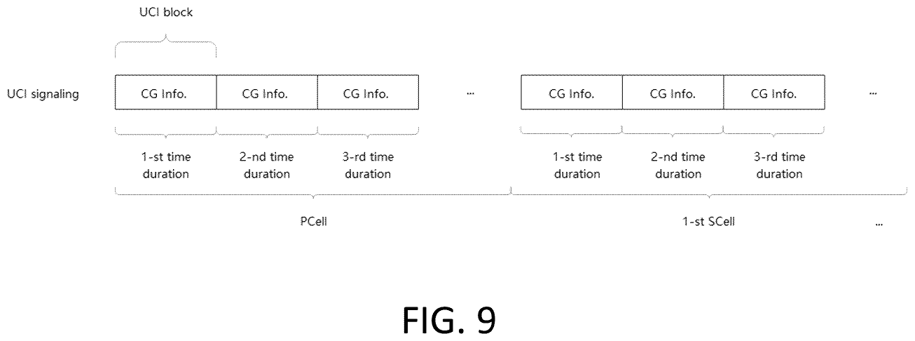

FIG. 9 shows a schematic diagram of a UCI content structure according to an embodiment of the present embodiment, In FIG. 9, the UCI indicates the unused transmission occasions for one or more cells in one or more time durations. Note that the UCI content is in an order of multiple time durations for the PCell, multiple time durations for the 1st SCell, and so on.

### Bit Matrix Form of Indication

In an embodiment, a bit matrix may be used for indicating the used transmission occasions and/or unused transmission occasions from one or more cells in one or more time durations.

For example, the bit matrix comprises information for: N-th transmission occasion of M-th CG configuration in the PCell and all SCells in the plurality of time durations, where N and M are integers.

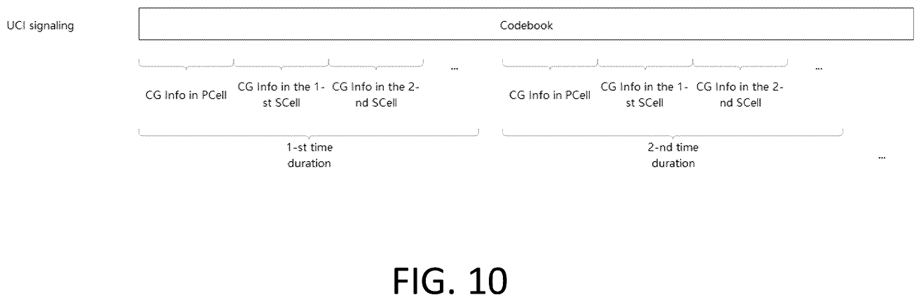

FIG. 10 shows a schematic diagram of the UCI content structure according to an embodiment of the present disclosure. In FIG. 10, the bit matrix indicates the transmission occasions of the CG configuration follows the order of indication for the CG configurations, and then follows the order of indication for cells in the first time duration. The same order of indication occurs in the subsequent time durations.

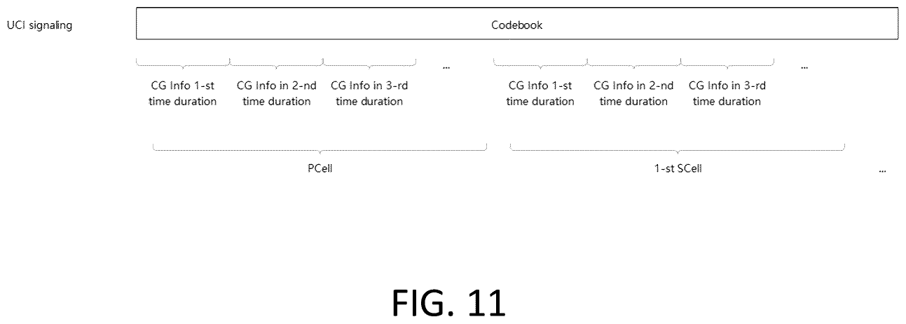

FIG. 11 shows a schematic diagram of the UCI content structure according to an embodiment of the present disclosure. In FIG. 11, the bit matrix indicates the transmission occasions of the CG configuration following the order of indication for CG configuration in a single cell and then following the order of indication for cells, where the transmission occasions of the CG configuration in one cell for all time durations are indicated first.

### When to Transmit UCI Indicating Multiple Cells

In an embodiment, the UCI is transmitted in all transmission occasions from the CG configurations in both PCell and SCell in a plurality of time duration (e.g., a plurality of CG periods).

In an embodiment, the UCI is transmitted in the 1st transmission occasion from the CG configurations in PCell in the first time duration.

In an embodiment, the UCI is transmitted in the 1st transmission occasion from the CG configurations in both PCell and SCell in the first time duration.

In an embodiment, the UCI is transmitted in the pre-configured (one or more) transmission occasion(s) from the CG configuration in PCell in the first time duration.

In an embodiment, the UCI is transmitted in the pre-configured (one or more) transmission occasions from the CG configurations in both PCell and SCell in the first time duration.

### UCI Indicates Unused Occasion Configured in Different Cell Groups

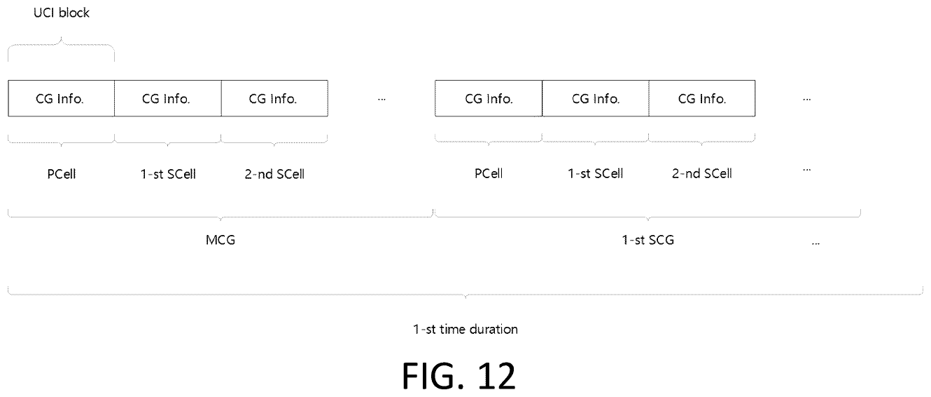

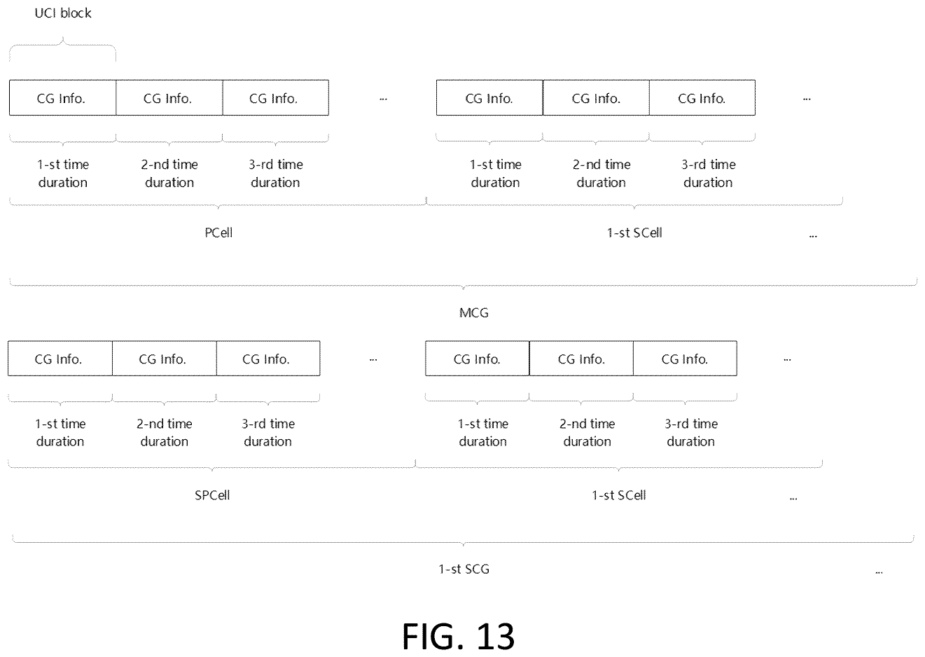

In some embodiments, the UCI indicates unused transmission occasions from CG configuration in one or more cell groups in one or more time durations as shown in FIGS. 12 and 13.

As shown in FIG. 12, the UCI consists of the bit blocks that indicates the transmission occasions of the CG configurations following the order of indication for cell groups within a time duration and then following the order of time duration. As shown in FIG. 13, the UCI consists of the bit blocks that indicates the transmission occasions of the CG configurations following the order of indication for time duration for a cell group and then following the order of cell groups.

### Bit Matrix Form of Indication

In an embodiment, a bit matrix may be used for indicate the unused transmission occasions and/or used transmission occasions from one or more cells in one or more time durations.

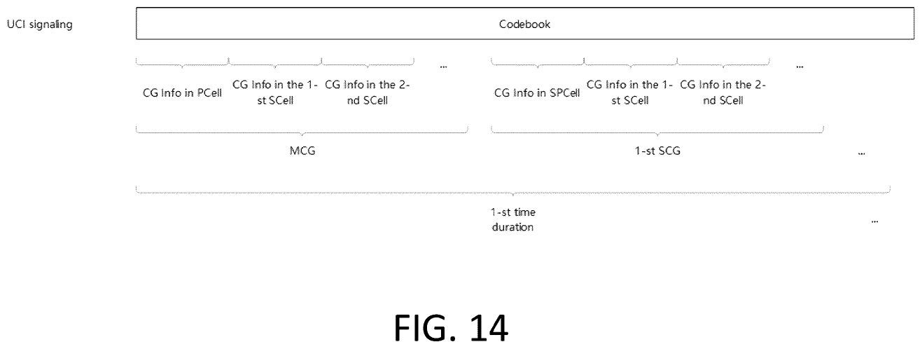

FIG. 14 shows a schematic diagram of a UCI content structure according to an embodiment of the present disclosure. In this embodiment, the bit matrix may comprise: N-th transmission occasions of M-th CG configuration in the PCell, SpCell and SCell of both MCG and SCG in the plurality of time durations, where N and M are integers.

As an alternative, the bit matrix first indicates the transmission occasions of the CG configuration following the order of indication for CG configurations, and then following the order of indication for cells in the first time duration. And the same order of indication occurs in the following all time durations. (i.e., bit matrix is encoded through time duration by time duration).

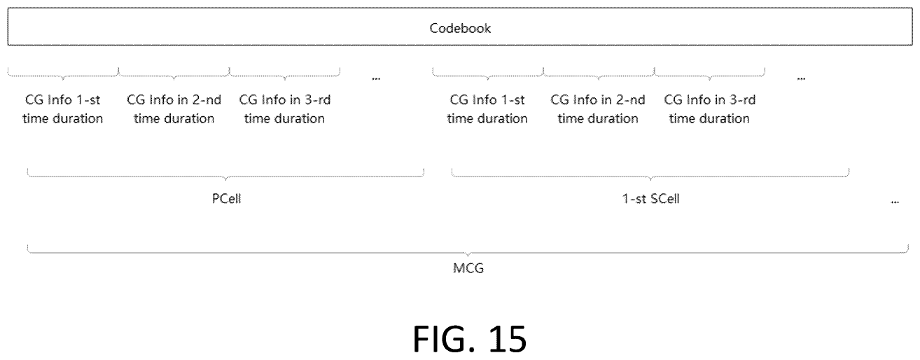

As an alternative, the bit matrix indicates the transmission occasions of the CG configuration first following the order of indication for CG configurations, and then following the order of indication for cells as shown in FIG. 15, where the transmission occasions of the CG configuration in one cell in all the following time durations are encoded first (i.e., bit matrix is encoded through Cell group by Cell group).

### When to Transmit UCI for Multiple Cell Groups:

In an embodiment, the UCI is transmitted in all transmission occasions from the CG configurations in both MCG and SCG in one time duration (e.g., a CG period)

In an embodiment, the UCI is transmitted in all transmission occasions from the CG configurations in both MCG and SCG in a plurality of time duration (e.g., a plurality of CG periods)

In an embodiment, the UCI is transmitted in all transmission occasions from the CG configurations in PCell of MCG in one or more time duration.

In an embodiment, the UCI is transmitted in all transmission occasions from the CG configuration in PCell of MCG and SpCell of SCG in one or more time duration.

In an embodiment, the UCI is transmitted in the first transmission occasion from the CG configuration in PCell of MCG in the first (1-st) time duration.

In an embodiment, the UCI is transmitted in the first transmission occasion from the CG configurations in both PCell and SCell of MCG in the first (1-st) time duration.

In an embodiment, the UCI is transmitted in the first transmission occasion from the CG configurations in both PCell & SCell of MCG and SpCell & SCell of SCG in the first (1-st) time duration.

In an embodiment, the UCI is transmitted in the first transmission occasion from the CG configurations in the PCell of MCG and SpCell of SCG in the first (1-st) time duration.

In an embodiment, the UCI is transmitted in the pre-configured (one or more) transmission occasions from the CG configuration in PCell of MCG in the first (1-st) time duration.

In an embodiment, the UCI is transmitted in the pre-configured (one or more) transmission occasions from the CG configurations in both PCell and SCell of MCG in the first (1-st) time duration.

In an embodiment, the UCI is transmitted in the pre-configured (one or more) transmission occasions from the CG configuration in both the PCell & SCell of MCG and the SpCell & SCell of SCG in the first (1-st) time duration.

In an embodiment, the UCI is transmitted in the pre-configured (one or more) transmission occasions from the CG configuration in both PCell of MCG and SpCell of SCG in the first (1-st) time duration.

### UCI Indicating Different TRPs

In some embodiments, the UCI indicates unused transmission occasions from CG configuration in one or more transmission and reception points (TRPs) in one or more time durations.

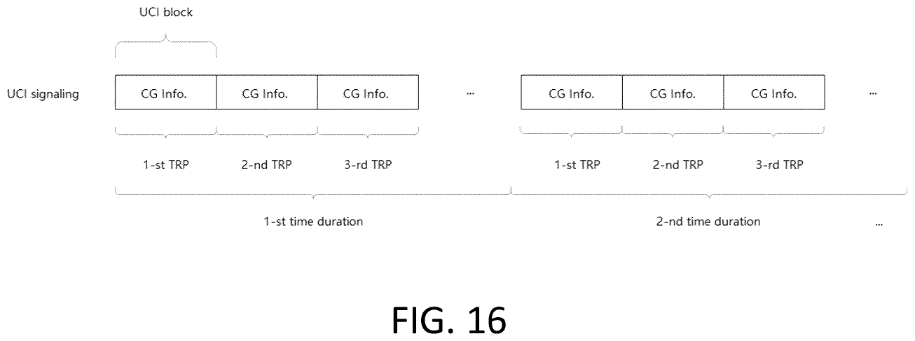

FIG. 16 shows a schematic diagram of a UCI structure according to an embodiment of the present disclosure. In FIG. 16, the UCI indicates the number of unused transmission occasions of the CG configuration in the first TRP in the first time duration into the first UCI blocks, the number of unused transmission occasions of the CG configuration in the first TRP in the second time duration and so on. Then the number of unused transmission occasions of the CG configuration in the second TRP in the first time duration into the following UCI blocks and so on. (i.e., indication is TRP by TRP).

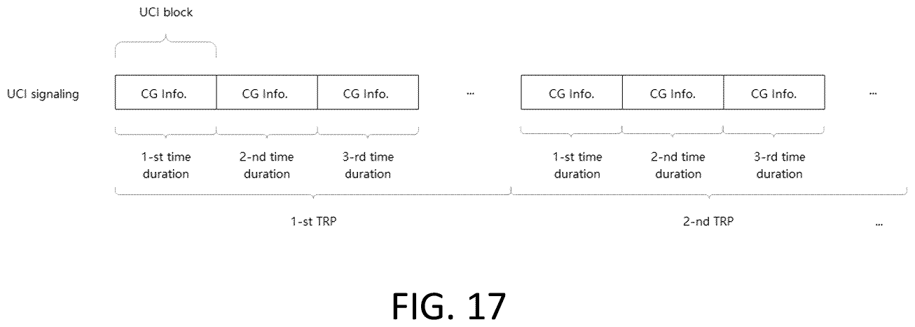

As an alternative, the UCI indicates the number of total unused transmission occasions of the CG configuration in first TRP in the plurality of time durations into the first UCI blocks, the total number of unused transmission occasions of the CG configuration in the second TRP in the plurality of time durations, and so on (see FIG. 17).

As an alternative, the indication information (e.g., bitmap) for the CG configuration in the first TRP in the first time duration is in the first UCI block, the indication information for the CG configuration in the second TRP in first time duration is in the second UCI block and so on. Then the indication for the CG configuration in the first TRP in the second time duration is in the following UCI block (i.e., indication is time duration by time duration).

As an alternative, the indication information (e.g., bitmap) for the CG configuration in the first TRP in the first time duration is in the first UCI block, the indication information for the CG configuration in the first TRP in the second time duration is in the second UCI block and so on, then the indication information (e.g., bitmap) for the CG configuration in the second TRP in the first time duration is in the following UCI block and so on. (i.e., indication is TRP by TRP.)

In an embodiment, a bit matrix for unused transmission occasions and/or unused transmission occasions from one or more TRPs in one or more time durations.

In this case, the bit matrix comprises: N-th transmission occasions of CG configuration in the TRPs in the plurality of time durations, where N and M are integers.

As an alternative, the bit matrix first indicates the transmission occasions of the CG configuration in the first TRP in the first time duration, the transmission occasions of the CG configuration in the second TRP in the first time duration and so on. Then the transmission occasions of the CG configuration in the first TRP in the second time duration, the transmission occasion of the CG configuration in the second TRP in the second time duration and so on. (i.e., bit matrix is encoded through time duration by time duration).

As an alternative, the bit matrix first indicates the transmission occasions of the CG configuration in the first TRP in the first time duration, the transmission occasions of the CG configuration in the first TRP in the second time duration and so on. Then the transmission occasions of the CG configuration in the second TRP in the first time duration, the transmission occasions of the CG configuration in the second TRP in the second time duration and so on. (i.e., bit matrix is encoded through TRP by TRP).

### When to Transmit UCI for Multiple TRPs:

In an embodiment, the UCI is transmitted in all transmission occasions from the CG configurations in all TRPs in one time duration (e.g., a CG period)

In an embodiment, the UCI is transmitted in all transmission occasions from the CG configurations in all TRPs in a plurality of time duration (e.g., a plurality of CG periods)

In an embodiment, the UCI is transmitted in the first transmission occasion from the CG configuration in first TRP in the first (1-st) time duration.

In an embodiment, the UCI is transmitted in the first transmission occasion from the CG configurations in all TRPs in the first (1-st) time duration.

In an embodiment, the UCI is transmitted in the pre-configured (one or more) transmission occasions from the CG configuration in first TRP in the first (1-st) time duration.

In an embodiment, the UCI is transmitted in the pre-configured (one or more) transmission occasions from the CG configurations in the pre-configured TRP in the first (1-st) time duration.

### UCI for One of CG Configurations

In some embodiments, the UCI indicates one selected CG configuration among the pre-configured CG configurations. For example, the UCI may indicate the index of selected CG configuration. The resource of a CG configuration is allowed to be overlapped in time or frequency domain with the resource of another CG configuration.

In some embodiments, the UCI contains an indication of ‘the UCI is used for 1 period’ or ‘the UCI is used for N periods’.

In an embodiment, the indication is a 1-bit flag in the UCI indicates that the UCI is used for 1 period or that the UCI is used for N>1 periods.

For example, UCI is 5 bits, and 1 bit indicates, whether UCI indicate the occasion in 1 period or not, other 4 bits is the indication of unused resources within 1 periods.

In an embodiment, The UCI is 9 bits, and 1 bit indicate, whether UCI indicate the occasion in 1 period or not, other 8 bits is the indication of unused resources within a time duration which can be two period.

In an embodiment, for the UCIs for the same time duration, the content of the UCIs should be the same.

In an embodiment, for the UCIs indicating the same time duration, if the content of one UCI is different from previous UCI, the 1 bit flag of the UCI may indicate 1 period is applied. In this embodiment, the override UCI only changes the unused occasions in one corresponding period.

### UE Reporting UE Capability

In an embodiment, the UE reports its UE capability on whether reporting the indication of unused of CG PUSCH occasions for multiple periods.

In an embodiment, the UE reports its UE capability on whether reporting the indication of unused of CG PUSCH occasions for multiple CG configurations, multiple carrier/cell, multiple TRPs.

In an embodiment, the UE reports its UE capability on whether report the indication of unused of CG PUSCH occasions for a shared spectrum.

### CG PUSCH Occasion Configuration

In an embodiment, the UCI mechanism is based on the configured CG PUSCH occasion within a time duration, e.g., within a CG Period. In the following, methods of how to configure multiple CG PUSCH occasions within a CG period are illustrated.

In an embodiment, the network (e.g., BS) configures the CG PUSCH occasions within a CG period via configuring the RRC parameters. For example, the network configures a Table, which is denoted as PUSCH-TimeDomainResourceAllocation SIZE (1 . . . maxN), the Table has maxN rows, wherein each row indicate the time domain resource allocation of multiple Configured grant PUSCHs in a CG period. For example, Each row is denoted as PUSCH-Allocation SIZE (1 . . . maxNrofMultiCG-PUSCH), wherein maxNrofMultiCG-PUSCH is the maximum number of CG PUSCHs in a CG period, e.g., maxNrofMultiCG-PUSCH=8.

Furthermore, each PUSCH-Allocation indicates a startSymbolAndLength and an offset.

In an embodiment, the startSymbolAndLength denotes start symbol position and the length of a PUSCH.

In an embodiment, the offset means/refers to the time offset between a PUSCH and a reference point.

For example, the startSymbolAndLength may be set as S, and length is denoted as L:

if (L−1)<=7 then
startSymbolAndLength = 14*(L−1)+S
else
startSymbolAndLength = 14*(15−L)+(13−S)
the value of startSymbolAndLength can be (0...127),

In an embodiment, a DCI format indicates a row index of a table, which is configured via the RRC (signaling). The configured Table may be the table in above embodiments, wherein each row indicates the time domain resource allocation of multiple Configured grant PUSCHs in a CG period.

In an embodiment, the offset can be time offset between a PUSCH and a reference point, and the reference point is the time slot when DCI is received.

In an embodiment, the bit field of time domain resource allocation in a DCI format (e.g., DCI format 0-0, format 0-1, DCI format 0-2) indicates an index, wherein the index is linked to a row of information in a TDRA table (e.g., the TDRA table can be that shown in above embodiments.

In an embodiment, the RRC parameters include:

ConfiguredGrantConfigForMultiPUSCHs, which contains rrc-ConfiguredUplinkGrantMultiPUSCHs.

In an embodiment, rrc-ConfiguredUplinkGrantMultiPUSCHs contains a time domain parameter that provides multiple timeDomainOffset and multiple PUSCH-Allocation.

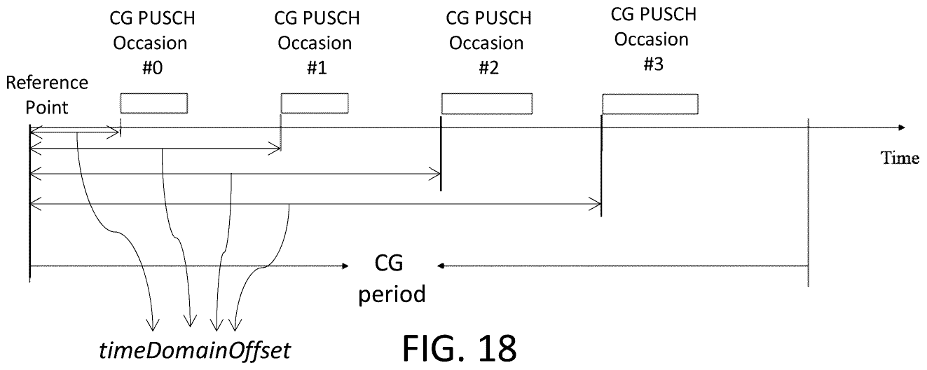

In an embodiment, the timeDomainOffset means/refers to the time offset between a PUSCH and a reference point (e.g., the time offset of each CG PUSCH related to the reference SFN, as shown in FIG. 18.

Specifically, each PUSCH-Allocation indicates a startSymbolAndLength.

The startSymbolAndLength denotes start symbol position and the length of a PUSCH.

The network may configure a table which contains multiple PUSCH-Allocation, the table can be as same as the above embodiments.

In an embodiment, the RRC parameters include ConfiguredGrantConfigForMultiPUSCHs.

In an embodiment, the ConfiguredGrantConfigForMultiPUSCHs contains rrc-ConfiguredUplinkGrantMultiPUSCHs, wherein the rrc-ConfiguredUplinkGrantMultiPUSCHs contains a time domain parameter that provides a timeDomainOffset and a sub-offset.

In an embodiment, the sub-offset denotes the time offset between adjacent CG PUSCH occasions.

In an embodiment, the network configures a new (TDRA) table for time domain resource allocation of multiple PUSCHs in a CG period. The new table contains PUSCH-Allocation and PUSCH-Allocation. Note that the table may not indicate the offset. The network configures at most 16 rows in this TDRA table, wherein each row contains multiple timeDomainAllocation.

In an embodiment, the formula in 3GPP TS 38.321 is reused, and each timeDomainOffset is applied to the formula for generating corresponding CG PUSCH occasion in next period and subsequent periods.

In an embodiment, the network may configure a new (TDRA) table for time domain resource allocation of multiple PUSCHs in a CG period. The network configures at most 32 rows in this TDRA table. In this embodiment, the network can indicate whether to use new TDRA table.

For example, a high layer signaling indicates whether a new TDRA table is used, wherein the TDRA table containing 32 rows and each row indicates the time domain resource allocation of multiple CG PUSCH occasions.

In an embodiment, the RRC parameters includes,

ConfiguredGrantConfigForMultiPUSCHs, wherein it contains rrc-ConfiguredUplinkGrantMultiPUSCHs. The rrc-ConfiguredUplinkGrantMultiPUSCHs contains time domain parameter that provides multiple timeDomainOffset, and a PUSCH-Allocation. The PUSCH-Allocation indicates a startSymbolAndLength.

### Determination of Resource Allocation Table to be Used for CG PUSCH

In the following, embodiments of tables for PUSCH time domain resource allocation configuration are shown.

TABLE 1
Applicable PUSCH time domain resource allocation

| | | pusch- | | pusch-Config | |
|---|---|---|---|---|---|
| | | ConfigCommon | pusch-Config | includes pusch- | |
| | | includes pusch- | includes pusch- | TimeDomainAllo- | |
| | PDCCH | TimeDomainAllo- | TimeDomainAllo- | cationList For | PUSCH time domain resource |
| RNTI | search space | cationList | cationList | Multi-PUSCH CG | allocation to apply |
| CS-RNTI | common search | No/Yes | No/Yes | Yes | TimeDomainAllo- |
| | space or DCI | | | | cationListForMultiPUSCH -18 |
| | format 0_0 in | | | | provided in pusch-Config |
| | UE specific | | | | |
| | search space | | | | |

TABLE 2
Applicable PUSCH time domain resource allocation for DCI format 0_1 in UE
specific search space scrambled with C-RNTI, MCS-C-RNTI, CS-RNTI or SP-CSI-RNTI

| | | | pusch-Config includes pusch- | | |
|---|---|---|---|---|---|
| pusch- | | | TimeDomainAllocationList- | pusch-Config | |
| ConfigCommon | pusch-Config | pusch-Config | ForMultiPUSCH or pusch- | includes pusch- | |
| includes pusch- | includes pusch- | includes pusch- | Config includes pusch- | TimeDomainAllo- | |
| TimeDomainAllo- | TimeDomainAllo- | TimeDomainAllo- | TimeDomainAllo- | cationList For | PUSCH time domain resource |
| cationList | cationList | cationListDCI-0-1 | cationListForMultiPUSCH-17 | Multi-PUSCH CG | allocation to apply |
| No/Yes | No/Yes | — | No/Yes | Yes | TimeDomainAllo- |
| | | | | | cationListForMultiPUSCH -18 |
| | | | | | provided in pusch-Config |

TABLE 3
Applicable PUSCH time domain resource allocation for DCI format 0_2 in UE
specific search space scrambled with C-RNTI, MCS-C-RNTI, CS-RNTI or SP-CSI-RNTI

| pusch- | | | pusch-Config | |
|---|---|---|---|---|
| ConfigCommon | pusch-Config | pusch-Config | includes pusch- | |
| includes pusch- | includes pusch- | includes pusch- | TimeDomainAllo- | |
| TimeDomainAllo- | TimeDomainAllo- | TimeDomainAllo- | cationList For | PUSCH time domain resource |
| cationList | cationList | cationListDCI-0-2 | Multi-PUSCH CG | allocation to apply |
| No/Yes | Yes | No | Yes | TimeDomainAllo- |
| | | | | cationListForMultiPUSCH -18 |
| | | | | provided in pusch-Config |

Note that TimeDomainAllocationListForMultiPUSCH-18 can be the table shown in the aforementioned embodiments.

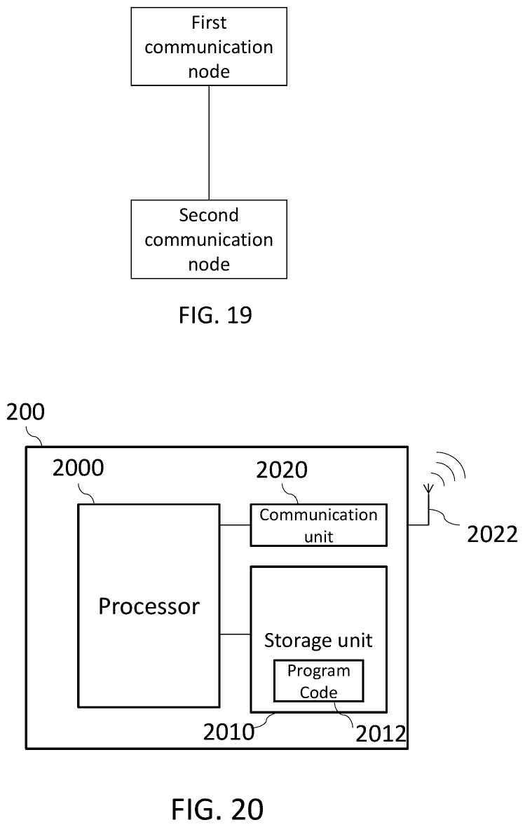

FIG. 19 shows a schematic diagram of a network (architecture) according to an embodiment of the present disclosure. The network (architecture) shown in FIG. 1 comprises a first communication node and a second communication node. The first communication node may be a UE, a wireless terminal, a wireless device, etc. The second communication node may be a BS, a gNB, an eNB, a repeater, a relay and so on.

FIG. 20 relates to a schematic diagram of a wireless terminal 200 according to an embodiment of the present disclosure. The wireless terminal 200 may be a user equipment (UE), a mobile phone, a laptop, a tablet computer, an electronic book or a portable computer system and is not limited herein. The wireless terminal 200 may include a processor 2000 such as a microprocessor or Application Specific Integrated Circuit (ASIC), a storage unit 2010 and a communication unit 2020. The storage unit 2010 may be any data storage device that stores a program code 2012, which is accessed and executed by the processor 2000. Embodiments of the storage unit 2010 include but are not limited to a subscriber identity module (SIM), read-only memory (ROM), flash memory, random-access memory (RAM), hard-disk, and optical data storage device. The communication unit 2020 may a transceiver and is used to transmit and receive signals (e.g., messages or packets) according to processing results of the processor 2000. In an embodiment, the communication unit 2020 transmits and receives the signals via at least one antenna 2022 shown in FIG. 20.

In an embodiment, the storage unit 2010 and the program code 2012 may be omitted and the processor 2000 may include a storage unit with stored program code.

The processor 2000 may implement any one of the steps in exemplified embodiments on the wireless terminal 200, e.g., by executing the program code 2012.

The communication unit 2020 may be a transceiver. The communication unit 2020 may as an alternative or in addition be combining a transmitting unit and a receiving unit configured to transmit and to receive, respectively, signals to and from a wireless network node (e.g., a base station).

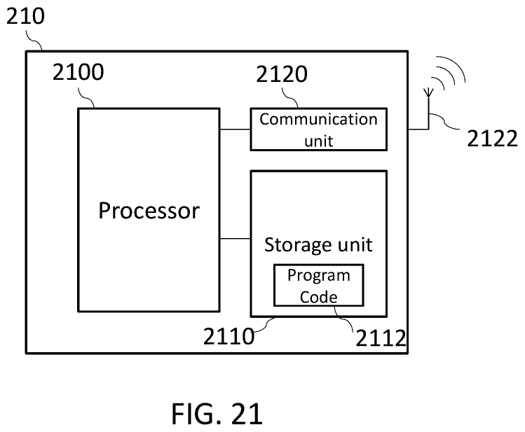

FIG. 21 relates to a schematic diagram of a wireless network node 210 according to an embodiment of the present disclosure. The wireless network node 210 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 210 may comprise (perform) at least one network function such as an access and mobility management function (AMF), a session management function (SMF), a user place function (UPF), a policy control function (PCF), an application function (AF), etc. The wireless network node 210 may include a processor 2100 such as a microprocessor or ASIC, a storage unit 2110 and a communication unit 2120. The storage unit 2110 may be any data storage device that stores a program code 2112, which is accessed and executed by the processor 2100. Examples of the storage unit 2110 include but are not limited to a SIM, ROM, flash memory, RAM, hard-disk, and optical data storage device. The communication unit 2120 may be a transceiver and is used to transmit and receive signals (e.g., messages or packets) according to processing results of the processor 2100. In an example, the communication unit 2120 transmits and receives the signals via at least one antenna 2122 shown in FIG. 21.

In an embodiment, the storage unit 2110 and the program code 2112 may be omitted. The processor 2100 may include a storage unit with stored program code.

The processor 2100 may implement any steps described in exemplified embodiments on the wireless network node 210, e.g., via executing the program code 2112.

The communication unit 2120 may be a transceiver. The communication unit 2120 may as an alternative or in addition be combining a transmitting unit and a receiving unit configured to transmit and to receive, respectively, signals to and from a wireless terminal (e.g., a user equipment or another wireless network node).

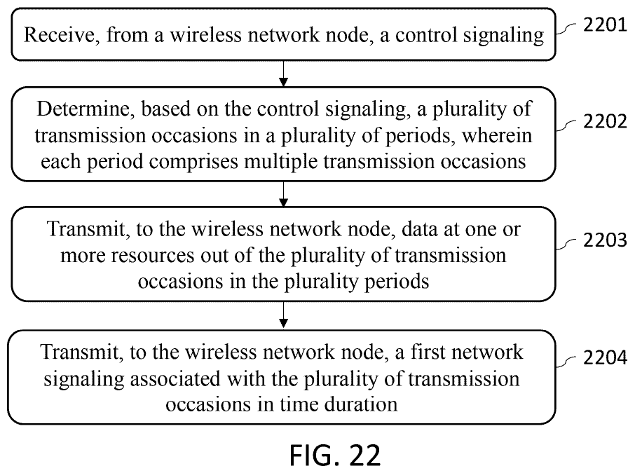

FIG. 22 shows a flowchart of a method according to an embodiment of the present disclosure. The method shown in FIG. 22 may be used in a wireless terminal (e.g. UE) and comprises the following steps:
Step 2201: Receive, from a wireless network node, a control signaling.
Step 2202: Determine, based on the control signaling, a plurality of transmission occasions in a plurality of periods, wherein each period comprises multiple transmission occasions.
Step 2203: Transmitting, to the wireless network node, data at one or more resources out of the plurality of transmission occasions in the plurality periods.
Step 2204: Transmit, to the wireless network node, a first network signaling associated with the plurality of transmission occasions in a time duration.

In FIG. 22, the wireless terminal receives a control signaling from a wireless network node (e.g., BS) and determines a plurality of transmission occasions in a plurality of periods. For example, the transmission occasions may be CG PUSCH (transmission) occasions. In an embodiment, each period comprises multiple transmission occasions. In an embodiment, the control signaling or the transmission occasions are for a specific type of service (e.g., XR service or service requiring periodic data transmissions). The wireless terminal transmits, to the wireless network node, data at one or more resources out of the plurality of transmission occasions in the plurality periods. The wireless terminal may transmit, to the wireless network node, a first network signaling associated with the plurality of transmission occasions in a time duration, e.g., to inform the wireless network node the used and/or unused transmission occasions in the time duration. Note that the used transmission occasion refers to the transmission occasion used for the data transmission and the unused transmission occasion denotes the transmission occasion not used for the data transmission. In this embodiment, the time duration comprises one or multiple periods. That is the first network signaling may indicate the used and/or unused transmission occasions in one or more periods.

In an embodiment, the first network signaling indicates a number of unused transmission occasions which is unused for transmitting the data transmission for all periods in the time duration.

In an embodiment, the first network signaling indicates a plurality of values for the multiple periods in the time duration, wherein each value indicates a number of unused transmission occasions which is unused for transmitting the data in corresponding period in the time duration.

In an embodiment, the first network signaling indicates a starting period in the time duration, For example, the transmission occasions in the starting period and the periods after the starting period in the time duration are unused for transmitting the data.

In an embodiment, the plurality of transmission occasions is configured by at least one of a plurality of configured grant (CG) configurations, a plurality of CG configuration groups, a plurality of serving cells, a plurality carriers or a plurality of transmission and reception points (TRPs).

In an embodiment, the first network signaling comprises/indicates at least one of:
one or multiple numbers of unused transmission occasions which are unused for transmitting the data within the one or more periods in the time duration,
one or multiple time windows associated with unused transmission occasions which are unused for transmitting the data in the time duration, or
a bit string indicates whether the transmission occasions in the time duration are used or unused for transmitting the data.

In an embodiment, the first network signaling indicates the transmission occasions unused for the data transmission in the time duration based on at least one characteristic of the transmission occasions in the time duration and the periods in the time duration (see, e.g., FIGS. 4 to 17).

In an embodiment, the first network signaling indicates the transmission occasions unused for transmitting the data in an order of a characteristic of the transmission occasions in the time duration and then in an order of the periods in the time duration (see, e.g., FIG. 4).

In an embodiment, the first network signaling indicates the transmission occasions unused for transmitting the data in the time duration in an order of the periods and then in an order of a characteristic (see, e.g., FIG. 5).

For instance, the the at least one characteristic of the unused transmission occasions comprises at least one of:
CG configurations,
CG groups,
cells,
cell groups,
carriers, or
TRPs.

In an embodiment, the first network signaling comprises a bit matrix indicating the transmission occasions unused for transmitting the data in the time duration, wherein columns of the bit matrix are associated with a first characteristic of the transmission occasions in the time duration and rows of the bit matrix are associated with a second characteristic of the transmission occasions in the time duration.

For example, the first characteristic and the second characteristic are two of: periods, CG configurations, CG groups, cells, cell groups, carriers, or TRPs.

In an embodiment, the first network signaling is transmitted in:
all of the transmission occasions in the time duration,
a 1st transmission occasion in a 1st period in the time duration,
the transmission occasions configured by a preconfigured CG configuration in the time duration,
the transmission occasions in a primary cell and/or a secondary cell in the time duration, or
the transmission occasions in a master cell group and/or a secondary group.

Note that the timing or the resource of transmitting the first network signaling is not limited herein and more embodiments can be found in previous paragraphs.

In an embodiment, the first network signaling indicates one of configurations for the plurality of transmissions occasions in the plurality of periods.

In an embodiment, the first network signaling comprises an indication of whether the first network signaling is used for multiple periods.

In an embodiment, the wireless terminal transmits, to the wireless network node, a second network signaling associated with the transmission occasions in one specific period of the periods in the time duration. In this embodiment, the second network indicates the used transmission occasions and/or unused transmission occasions in the specific period. In other words, the wireless terminal may update the information of the transmission occasions in the specific period in the time duration.

In an embodiment, the wireless terminal transmits, to the wireless network node, UE capability information associated with transmitting the first network signaling.

In an embodiment, the control signaling comprises a plurality of sets of a time domain offset parameter and a time domain allocation parameter corresponding to the transmission occasions in each period.

In an embodiment, the time domain offset parameter indicates an offset relative to a reference subframe number.

In an embodiment, the time domain allocation parameter indicates a starting position and a time length.

In an embodiment, the control signaling indicates the plurality of sets of the time domain offset parameter and the time domain allocation parameter via a table configured by the wireless network node.

In an embodiment, the time domain allocation parameter for all of transmission occasions are the same.

In an embodiment, the control signaling is received in a DCI format.

In an embodiment, the DCI format indicates multiple time domain offsets and a row index of a table configured by the wireless network node.

In an embodiment, each time domain offset indicates a time offset between one transmission occasion and a reference point which is a time slot in which the DCI format is received.

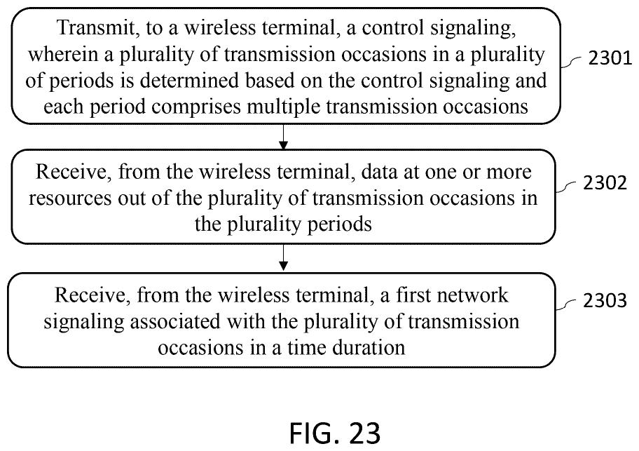

FIG. 23 shows a flowchart of a method according to an embodiment of the present disclosure. The method shown in FIG. 23 may be used in a wireless network node (e.g., BS) and comprises the following steps:
Step 2301: Transmit, to a wireless terminal, a control signaling, wherein a plurality of transmission occasions in a plurality of periods is determined based on the control signaling and each period comprises multiple transmission occasions.
Step 2302: Receive, from the wireless terminal, data at one or more resources out of the plurality of transmission occasions in the plurality periods.
Step 2303: Receive, from the wireless terminal, a first network signaling associated with the plurality of transmission occasions in a time duration.

In FIG. 23, the wireless network node transmits a control signaling to a wireless terminal (e.g., UE), for (configuring) a plurality of transmission occasions in a plurality of periods. In an embodiment, each period comprises multiple transmission occasions. The wireless network node receives, from the wireless terminal, data at/on one or more resources out of the plurality of transmission occasions in the plurality periods. The wireless network node further receives, from the wireless terminal, a first network signaling associated with the plurality of transmission occasions in a time duration. In this embodiment, the time duration comprises one or multiple periods.

In an embodiment, the first network signaling indicates a number of unused transmission occasions which is unused for transmitting the data transmission for all periods in the time duration.

In an embodiment, the first network signaling indicates a plurality of values for the multiple periods in the time duration, wherein each value indicates a number of unused transmission occasions which is unused for transmitting the data in corresponding period in the time duration.

In an embodiment, the first network signaling indicates a starting period in the time duration, For example, the transmission occasions in the starting period and the periods after the starting period in the time duration are unused for transmitting the data.

In an embodiment, the plurality of transmission occasions is configured by at least one of a plurality of configured grant (CG) configurations, a plurality of CG configuration groups, a plurality of serving cells, a plurality carriers or a plurality of transmission and reception points (TRPs).

In an embodiment, the first network signaling comprises/indicates at least one of:
one or multiple numbers of unused transmission occasions which are unused for transmitting the data within the one or more periods in the time duration,
one or multiple time windows associated with unused transmission occasions which are unused for transmitting the data in the time duration, or
a bit string indicates whether the transmission occasions in the time duration are used or unused for transmitting the data.

In an embodiment, the first network signaling indicates the transmission occasions unused for the data transmission in the time duration based on at least one characteristic of the transmission occasions in the time duration and the periods in the time duration (see, e.g., FIGS. 4 to 17).

In an embodiment, the first network signaling indicates the transmission occasions unused for transmitting the data in an order of a characteristic of the transmission occasions in the time duration and then in an order of the periods in the time duration (see, e.g., FIG. 4).

In an embodiment, the first network signaling indicates the transmission occasions unused for transmitting the data in the time duration in an order of the periods and then in an order of a characteristic (see, e.g., FIG. 5).

For instance, the the at least one characteristic of the unused transmission occasions comprises at least one of:
CG configurations,
CG groups,
cells,
cell groups,
carriers, or
TRPs.

In an embodiment, the first network signaling comprises a bit matrix indicating the transmission occasions unused for transmitting the data in the time duration, wherein columns of the bit matrix are associated with a first characteristic of the transmission occasions in the time duration and rows of the bit matrix are associated with a second characteristic of the transmission occasions in the time duration.

For example, the first characteristic and the second characteristic are two of: periods, CG configurations, CG groups, cells, cell groups, carriers, or TRPs.

In an embodiment, the first network signaling is transmitted in:
all of the transmission occasions in the time duration,
a 1st transmission occasion in a 1st period in the time duration,
the transmission occasions configured by a preconfigured CG configuration in the time duration,
the transmission occasions in a primary cell and/or a secondary cell in the time duration, or
the transmission occasions in a master cell group and/or a secondary group.

Note that the timing or the resource of transmitting the first network signaling is not limited herein and more embodiments can be found in previous paragraphs.

In an embodiment, the first network signaling indicates one of configurations for the plurality of transmissions occasions in the plurality of periods.

In an embodiment, the first network signaling comprises an indication of whether the first network signaling is used for multiple periods.

In an embodiment, the wireless network node receives, from the wireless terminal, a second network signaling associated with the transmission occasions in one specific period of the periods in the time duration. In this embodiment, the second network indicates the used transmission occasions and/or unused transmission occasions in the specific period. In other words, the information of the transmission occasions in the specific period in the time duration may be updated.

In an embodiment, the wireless network node receives, from the wireless terminal, UE capability information associated with transmitting the first network signaling.

In an embodiment, the control signaling comprises a plurality of sets of a time domain offset parameter and a time domain allocation parameter corresponding to the transmission occasions in each period.

In an embodiment, the time domain offset parameter indicates an offset relative to a reference subframe number.

In an embodiment, the time domain allocation parameter indicates a starting position and a time length.

In an embodiment, the control signaling indicates the plurality of sets of the time domain offset parameter and the time domain allocation parameter via a table configured by the wireless network node.

In an embodiment, the time domain allocation parameter for all of transmission occasions are the same.

In an embodiment, the control signaling is transmitted in a DCI format.

In an embodiment, the DCI format indicates multiple time domain offsets and a row index of a table configured by the wireless network node.

In an embodiment, based on the first network signaling and/or second network signaling, the wireless network node may reschedule/reconfigure/recycle the resource of unused transmission occasions to other purposes, e.g., data transmission/reception from the wireless terminal or another wireless terminal.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

What is claimed is:

1. A wireless communication method for use in a wireless terminal, the wireless communication method comprising:
receiving, from a wireless network node, a control signaling,
determining, based on the control signaling, a plurality of transmission occasions in a plurality of periods, wherein each period comprises multiple transmission occasions,
transmitting, to the wireless network node, data at one or more resources out of the plurality of transmission occasions in the plurality periods, and
transmitting, to the wireless network node, a first network signaling associated with the plurality of transmission occasions in a time duration, wherein the time duration comprises one or multiple periods.

2. The wireless communication method of claim 1, wherein the first network signaling indicates a number of unused transmission occasions which is unused for transmitting the data transmission for all periods in the time duration, or
wherein the first network signaling indicates a plurality of values for the multiple periods in the time duration, wherein each value indicates a number of unused transmission occasions which is unused for transmitting the data in corresponding period in the time duration.

3. The wireless communication method of claim 1, wherein the first network signaling indicates a starting period in the time duration,
wherein the transmission occasions in the starting period and the periods after the starting period in the time duration are unused for transmitting the data,
wherein the plurality of transmission occasions is configured by at least one of a plurality of configured grant (CG) configurations, a plurality of CG configuration groups, a plurality of serving cells, a plurality of carriers or a plurality of transmission and reception points (TRPs).

4. The wireless communication method of claim 1, wherein the first network signaling comprises at least one of:
one or multiple numbers of unused transmission occasions which are unused for transmitting the data within the one or more periods in the time duration,
one or multiple time windows associated with unused transmission occasions which are unused for transmitting the data in the time duration, or
a bit string indicates whether the transmission occasions in the time duration are used or unused for transmitting the data,
wherein the first network signaling indicates the transmission occasions unused for transmitting the data in the time duration based on at least one characteristic of the transmission occasions in the time duration and the periods in the time duration,
wherein the unused transmission occasions are the transmission occasions unused for transmitting the data,
wherein the at least one characteristic of the unused transmission occasions comprises at least one of:
CG configurations,
CG groups,
cells,
cell groups,
carriers, or
TRPs.

5. The wireless communication method of claim 1, wherein:
the first network signaling indicates the transmission occasions unused for transmitting the data in an order of a characteristic of the transmission occasions in the time duration and then in an order of the periods in the time duration, or
the first network signaling indicates the transmission occasions unused for transmitting the data in the time duration in an order of the periods and then in an order of a characteristic,
wherein the characteristic is one of:
CG configurations,
CG groups,
cells,
cell groups,
carriers, or
TRPs.

6. The wireless communication method of claim 1, wherein the first network signaling comprises a bit matrix indicating the transmission occasions unused for transmitting the data in the time duration, wherein columns of the bit matrix are associated with a first characteristic of the transmission occasions in the time duration and rows of the bit matrix are associated with a second characteristic of the transmission occasions in the time duration,
wherein the first characteristic and the second characteristic are two of:
periods,
CG configurations,
CG groups,
cells,
cell groups,
carriers, or
TRPs.

7. The wireless communication method of claim 1, wherein the first network signaling is transmitted in:
all of the transmission occasions in the time duration,
a 1^{st} transmission occasion in a 1^{st} period in the time duration,
the transmission occasions configured by a preconfigured CG configuration in the time duration,
the transmission occasions in a primary cell and/or a secondary cell in the time duration, or
the transmission occasions in a master cell group and/or a secondary group,
wherein the first network signaling indicates one of configurations for the plurality of transmissions occasions in the plurality of periods,
wherein the first network signaling comprises an indication of whether the first network signaling is used for multiple periods.

8. The wireless communication method of claim 1, further comprising:
transmitting, to the wireless network node, a second network signaling associated with the transmission occasions in one of the periods in the time duration,
wherein the second network indicates the used transmission occasions which are used for a data transmission and/or unused transmission occasions which are unused for the data transmission in the period,
further comprising:
transmitting, to the wireless network node, UE capability information associated with transmitting the first network signaling.

9. The wireless communication method of claim 1, wherein the control signaling comprises a plurality of sets of a time domain offset parameter and a time domain allocation parameter corresponding to the transmission occasions in each period,
wherein the time domain offset parameter indicates an offset relative to a reference subframe number,
wherein the time domain allocation parameter indicates a starting position and a time length,
wherein the control signaling indicates the plurality of sets of the time domain offset parameter and the time domain allocation parameter via a table configured by the wireless network node,
wherein the time domain allocation parameter for all of transmission occasions are the same,
wherein the control signaling is received in a DCI format,
wherein the DCI format indicates multiple time domain offsets and a row index of a table configured by the wireless network node, and
wherein each offset indicates a time offset between one transmission occasion and a reference point which is a time slot in which the DCI format is received.

10. A wireless communication method for use in a wireless network node, the method comprising:
transmitting, to a wireless terminal, a control signaling, wherein a plurality of transmission occasions in a plurality of periods is determined based on the control signaling and each period comprises multiple transmission occasions,
receiving, from the wireless terminal, data at one or more resources out of the plurality of transmission occasions in the plurality periods, and
receiving, from the wireless terminal, a first network signaling associated with the plurality of transmission occasions in a time duration, wherein the time duration comprises one or multiple periods.

11. The wireless communication method of claim 10, wherein the first network signaling indicates a number of unused transmission occasions which is unused for transmitting the data transmission for all periods in the time duration, or
wherein the first network signaling indicates a plurality of values for the multiple periods in the time duration, wherein each value indicates a number of unused transmission occasions which is unused for transmitting the data in corresponding period in the time duration.

12. The wireless communication method of claim 10, wherein the first network signaling indicates a starting period in the time duration,
wherein the transmission occasions in the starting period and the periods after the starting period in the time duration are unused for transmitting the data,
wherein the plurality of transmission occasions is configured by at least one of a plurality of configured grant (CG) configurations, a plurality of CG configuration groups, a plurality of serving cells, a plurality of carriers or a plurality of transmission and reception points (TRPs).

13. The wireless communication method of claim 10, wherein the first network signaling comprises at least one of:
one or multiple numbers of unused transmission occasions which are unused for transmitting the data within the one or more periods in the time duration,
one or multiple time windows associated with unused transmission occasions which are unused for transmitting the data in the time duration, or
a bit string indicates whether the transmission occasions in the time duration are used or unused for transmitting the data,
wherein the first network signaling indicates the transmission occasions unused for transmitting the data in the time duration based on at least one characteristic of the transmission occasions in the time duration and the periods in the time duration,
wherein the unused transmission occasions are the transmission occasions unused for transmitting the data,
wherein the at least one characteristic of the unused transmission occasions comprises at least one of:
CG configurations,
CG groups,
cells,
cell groups,
carriers, or
TRPs.

14. The wireless communication method of claim 10, wherein the first network signaling indicates the transmission occasions unused for transmitting the data in an order of a characteristic of the transmission occasions in the time duration and then in an order of the periods in the time duration, or
the first network signaling indicates the transmission occasions unused for transmitting the data in the time duration in an order of the periods and then in an order of a characteristic,
wherein the characteristic is one of:
CG configurations,
CG groups,
cells,
cell groups,
carriers, or
TRPs.

15. The wireless communication method of claim 10, wherein the first network signaling comprises a bit matrix indicating the transmission occasions unused for transmitting the data in the time duration, wherein columns of the bit matrix are associated with a first characteristic of the transmission occasions in the time duration and rows of the bit matrix are associated with a second characteristic of the transmission occasions in the time duration,
wherein the first characteristic and the second characteristic are two of:
periods,
CG configurations,
CG groups,
cells,
cell groups,
carriers, or
TRPs.

16. The wireless communication method of claim 10, wherein the first network signaling is transmitted in:
all of the transmission occasions in the time duration,
a 1^{st} transmission occasion in a 1^{st} period in the time duration,
the transmission occasions configured by a preconfigured CG configuration in the time duration,
the transmission occasions in a primary cell and/or a secondary cell in the time duration, or
the transmission occasions in a master cell group and/or a secondary group,
wherein the first network signaling indicates one of configurations for the plurality of transmissions occasions in the plurality of periods,
wherein the first network signaling comprises an indication of whether the first network signaling is used for multiple periods.

17. The wireless communication method of claim 10, further comprising:
receiving, from the wireless terminal, a second network signaling associated with the transmission occasions in one of the periods in the time duration,
wherein the second network indicates the used transmission occasions which are used for a data transmission and/or unused transmission occasions which are unused for the data transmission in the period,
further comprising:
receiving, from the wireless terminal, UE capability information associated with transmitting the first network signaling.

18. The wireless communication method of claim 10, wherein the control signaling comprises a plurality of sets of a time domain offset parameter and a time domain allocation parameter corresponding to the transmission occasions in each period,
wherein the time domain offset parameter indicates an offset relative to a reference subframe number,
wherein the time domain allocation parameter indicates a starting position and a time length,
wherein the control signaling indicates the plurality of sets of the time domain offset parameter and the time domain allocation parameter via a table configured by the wireless network node,
wherein the time domain allocation parameter for all of transmission occasions are the same.

19. The wireless communication method of claim 10, wherein the control signaling is transmitted in a DCI format,
wherein the DCI format indicates multiple time domain offsets and a row index of a table configured by the wireless network node, and
wherein each offset indicates a time offset between one transmission occasion and a reference point which is a time slot in which the DCI format is received.

20. A wireless terminal, comprising:
a communication unit, configured to receive, from a wireless network node, a control signaling,
a processor, configured to determine based on the control signaling, a plurality of transmission occasions in a plurality of periods, wherein each period comprises multiple transmission occasions,
wherein the communication unit is further configured to:
transmit, to the wireless network node, data at one or more resources out of the plurality of transmission occasions in the plurality periods, and
transmit, to the wireless network node, a first network signaling associated with the plurality of transmission occasions in a time duration, wherein the time duration comprises one or multiple periods.
